(19) United States
(12) Patent Application Publication
(10) Pub. No.: US 2024/0357171 A1
(43) Pub. Date: Oct. 24, 2024

(54) THREE-DIMENSIONAL DATA DECODING METHOD, THREE-DIMENSIONAL DATA ENCODING METHOD, THREE-DIMENSIONAL DATA DECODING DEVICE, AND THREE-DIMENSIONAL DATA ENCODING DEVICE

(71) Applicant: Panasonic Intellectual Property Corporation of America, Torrance, CA (US)

(72) Inventors: Toshiyasu SUGIO, Osaka (JP); Noritaka IGUCHI, Osaka (JP); Takahiro NISHI, Nara (JP); Zheng WU, Singapore (SG); Keng Liang LOI, Singapore (SG); Chung Dean HAN, Johor Bahru (MY)

(21) Appl. No.: 18/763,032

(22) Filed: Jul. 3, 2024

Related U.S. Application Data
(63) Continuation-in-part of application No. PCT/JP2022/044313, filed on Dec. 1, 2022.
(60) Provisional application No. 63/298,764, filed on Jan. 12, 2022.

(51) Int. Cl. H04N 19/597; H04N 19/13; H04N 19/96

(52) U.S. Cl. CPC H04N 19/597; H04N 19/13; H04N 19/96

(57) ABSTRACT

A three-dimensional data decoding method includes: obtaining a bitstream including encoded three-dimensional points generated by encoding three-dimensional points each of which is represented by a first angle, a second angle, and a distance; determining a reference three-dimensional point among the three-dimensional points; and performing, according to the first angle of the reference three-dimensional point, at least one of arithmetic decoding or debinarizing on encoded information of a current encoded three-dimensional point included in the encoded three-dimensional points to generate information of a current three-dimensional point included in the three-dimensional points, the information excluding the first angle.

### CROSS REFERENCE TO RELATED APPLICATIONS

This application is a U.S. continuation application of PCT International Patent Application Number PCT/JP2022/044313 filed on Dec. 1, 2022, claiming the benefit of priority of U.S. Provisional Patent Application No. 63/298,764 filed on Jan. 12, 2022, the entire contents of which are hereby incorporated by reference.

### FIELD

The present disclosure relates to a three-dimensional data decoding method, a three-dimensional data encoding method, a three-dimensional data decoding device, and a three-dimensional data encoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

PTL 1: International Publication WO 2014/020663

### SUMMARY

### Technical Problem

In encoding processing and decoding processing of three-dimensional data, there is a desire to be able to improve encoding efficiency.

The present disclosure provides a three-dimensional data decoding method, a three-dimensional data encoding method, a three-dimensional data decoding device, or a three-dimensional data encoding device capable of improving encoding efficiency.

### Solution to Problem

A three-dimensional data decoding method according to an aspect of the present disclosure includes: obtaining a bitstream including encoded three-dimensional points generated by encoding three-dimensional points each of which is represented by a first angle, a second angle, and a distance; determining a reference three-dimensional point among the three-dimensional points; and performing, according to the first angle of the reference three-dimensional point, at least one of arithmetic decoding or debinarizing on encoded information of a current encoded three-dimensional point included in the encoded three-dimensional points to generate information of a current three-dimensional point included in the three-dimensional points, the information excluding the first angle.

A three-dimensional data encoding method according to an aspect of the present disclosure includes: determining a reference three-dimensional point among three-dimensional points each of which is represented by a first angle, a second angle, and a distance; and performing, according to the first angle of the reference three-dimensional point, at least one of arithmetic encoding or binarizing on information of a current three-dimensional point included in the three-dimensional points, the information excluding the first angle.

### Advantageous Effects

The present disclosure can provide a three-dimensional data decoding method, a three-dimensional data encoding method, a three-dimensional data decoding device, or a three-dimensional data encoding device capable of improving encoding efficiency.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of a relationship between a laser ID and distance or horizontal angle according to an embodiment.

FIG. 2 is a block diagram of a three-dimensional data encoding device according to the embodiment.

FIG. 3 is a block diagram of a three-dimensional data decoding device according to the embodiment.

FIG. 4 is a block diagram of an entropy encoder according to the embodiment.

FIG. 5 is a block diagram of an entropy decoder according to the embodiment.

FIG. 6 is a diagram illustrating an example of an exponential-Golomb code according to the embodiment.

FIG. 7 is a diagram illustrating an example of an exponential-Golomb code according to the embodiment.

FIG. 8 is a diagram illustrating an example of an exponential-Golomb code according to the embodiment.

FIG. 9 is a diagram illustrating an example of a syntax of a header of encoded geometry information according to the embodiment.

FIG. 10 is a diagram illustrating another example of a syntax of a header of encoded geometry information according to the embodiment.

FIG. 11 is a flowchart of switching processing in an encoding method according to the embodiment.

FIG. 12 is a flowchart of switching processing in a decoding method according to the embodiment.

FIG. 13 is a diagram illustrating an example of a syntax of encoded data of geometry information according to the embodiment.

FIG. 14 is a flowchart of three-dimensional data decoding processing according to the embodiment.

FIG. 15 is a flowchart of three-dimensional data encoding processing according to the embodiment.

### DESCRIPTION OF EMBODIMENTS

A three-dimensional data decoding method according to an aspect of the present disclosure includes: obtaining a bitstream including encoded three-dimensional points generated by encoding three-dimensional points each of which is represented by a first angle, a second angle, and a distance; determining a reference three-dimensional point among the three-dimensional points; and performing, according to the first angle of the reference three-dimensional point, at least one of arithmetic decoding or debinarizing on encoded information of a current encoded three-dimensional point included in the encoded three-dimensional points to generate information of a current three-dimensional point included in the three-dimensional points, the information excluding the first angle.

Accordingly, in a case where, for example, information of a three-dimensional point has a tendency that is dependent on the first angle, a three-dimensional data encoding device that generates a bitstream can improve encoding efficiency by using a method (aspect) of at least one of arithmetic encoding or binarizing that is in accordance with the tendency. The three-dimensional data decoding method can appropriately decode the bitstream for which the encoding efficiency has been improved. Furthermore, by improving the encoding efficiency of the bitstream, the data amount of the bitstream can be reduced, and thus the processing amount in the three-dimensional data decoding method can be reduced.

It should be noted that a tendency that is dependent on the first angle includes, for example, a relationship in which the value of information to be encoded is bigger as the first angle is bigger, a relationship in which the value of information to be encoded is smaller as the first angle is bigger, a relationship in which the range of the value of information to be encoded is restricted when the first angle is substantially equal to a predetermined value, and so on. In other words, a tendency that is dependent on the first angle is a tendency in which the value of information to be encoded is identified from the first angle.

For example, the reference three-dimensional point may be the same as the current three-dimensional point.

Accordingly, a three-dimensional data encoding device that generates a bitstream can switch the method of the at least one of arithmetic decoding or debinarizing of information of the current three-dimensional point excluding the first angle, according to the first angle of the current three-dimensional point. Specifically, in this aspect, the information excluding the first angle is decoded after the first angle, according to the first angle that is decoded before the current three-dimensional point. Here, it is more likely that the tendency of the information of the current three-dimensional point is represented by the first angle of the current three-dimensional point than a first angle of a three-dimensional point other than the current three-dimensional point. Therefore, the three-dimensional data encoding device may be able to improve encoding efficiency compared to when the first angle of a three-dimensional point other than the current three-dimensional point is referred to. The three-dimensional data decoding method can appropriately decode the bitstream for which the encoding efficiency has been improved. Furthermore, by improving the encoding efficiency of the bitstream, the data amount of the bitstream can be reduced, and thus the processing amount in the three-dimensional data decoding method can be reduced.

For example, the reference three-dimensional point may correspond to a parent node of the current three-dimensional point, in a predictive tree of the three-dimensional points.

A predictive tree is a data structure generated according to prediction processing of a three-dimensional point. Therefore, it is highly likely that a tendency exists between the first angle of the reference three-dimensional point corresponding to a parent node and the information of the current three-dimensional point corresponding to the child node thereof. Furthermore, the three-dimensional data decoding method can reduce the processing delay on the decoding of the first angle since the reference three-dimensional point corresponding to the parent node is decoded before the current three-dimensional point.

For example, a first scheme of the at least one of the arithmetic decoding or the debinarizing may be used when the first angle is greater than a threshold, and a second scheme of the at least one of the arithmetic decoding or the debinarizing may be used when the first angle is less than or equal to the threshold, the second scheme being different from the first scheme.

Accordingly, in a case where, for example, information of a three-dimensional point has a tendency that is dependent on whether the first angle is greater than a threshold, that is, a tendency that is dependent on the range the first angle, a three-dimensional data encoding device that generates a bitstream can improve encoding efficiency by using a method of at least one of arithmetic encoding or binarizing that is in accordance with the tendency. The three-dimensional data decoding method can appropriately decode the bitstream for which the encoding efficiency has been improved. Furthermore, by improving the encoding efficiency of the bitstream, the data amount of the bitstream can be reduced, and thus the processing amount in the three-dimensional data decoding method can be reduced.

For example, a first context used in the first scheme of the arithmetic decoding may be different from a second context used in the second scheme of the arithmetic decoding.

Accordingly, a three-dimensional data encoding device that generates a bitstream can improve encoding efficiency in a case where, for example, information of a three-dimensional point has a tendency that is dependent on the first angle, by switching contexts in accordance with the first angle. The three-dimensional data decoding method can appropriately decode the bitstream for which the encoding efficiency has been improved. Furthermore, by improving the encoding efficiency of the bitstream, the data amount of the bitstream can be reduced, and thus the processing amount in the three-dimensional data decoding method can be reduced.

For example, a first bit length of a binarized symbol in the first scheme of the debinarizing may be different from a second bit length of a binarized symbol in the second scheme of the debinarizing.

Accordingly, a three-dimensional data encoding device that generates a bitstream can improve encoding efficiency in a case where, for example, information of a three-dimensional point has a tendency that is dependent on the first angle, by switching binarized symbols in accordance with the first angle. The three-dimensional data decoding method can appropriately decode the bitstream for which the encoding efficiency has been improved. Furthermore, by improving the encoding efficiency of the bitstream, the data amount of the bitstream can be reduced, and thus the processing amount in the three-dimensional data decoding method can be reduced.

For example, the encoded three-dimensional points may be decoded in ascending order of the first angles of the three-dimensional points, and when the first angle is greater than a threshold, a context of the arithmetic decoding may be initialized.

Accordingly, a three-dimensional data encoding device that generates a bitstream can use a different context when the first angle is greater than the threshold and when the first angle is less than or equal to the first angle, by initializing the context when the first angle is greater than the threshold. Consequently, the three-dimensional data encoding device can improve encoding efficiency in a case where, for example, information of a three-dimensional point has a tendency that is dependent on the first angle. The three-dimensional data decoding method can appropriately decode the bitstream for which the encoding efficiency has been improved. Furthermore, by improving the encoding efficiency of the bitstream, the data amount of the bitstream can be reduced, and thus the processing amount in the three-dimensional data decoding method can be reduced.

For example, the information may include at least one of the second angle, the distance, or prediction information of the current three-dimensional point.

Accordingly, the three-dimensional data decoding method can appropriately decode a bitstream for which encoding efficiency of at least one of the second angle, the distance, or the prediction information has been improved.

For example, the first angle may be an elevation angle and the second angle may be a horizontal angle, and the first angle may correspond to a laser ID used for generating the three-dimensional points.

Accordingly, in a case where, for example, information of a three-dimensional point has a tendency that is dependent on the range of a vertical direction position of the three-dimensional point, or the like, a three-dimensional data encoding device that generates a bitstream can improve encoding efficiency by using a method of at least one of arithmetic encoding or binarizing that is in accordance with the tendency. The three-dimensional data decoding method can appropriately decode the bitstream for which the encoding efficiency has been improved. Furthermore, by improving the encoding efficiency of the bitstream, the data amount of the bitstream can be reduced, and thus the processing amount in the three-dimensional data decoding method can be reduced.

A three-dimensional data encoding method according to an aspect of the present disclosure includes: determining a reference three-dimensional point among three-dimensional points each of which is represented by a first angle, a second angle, and a distance; and performing, according to the first angle of the reference three-dimensional point, at least one of arithmetic encoding or binarizing on information of a current three-dimensional point included in the three-dimensional points, the information excluding the first angle.

Accordingly, in a case where, for example, information of a three-dimensional point has a tendency that is dependent on the first angle, the three-dimensional data encoding method can improve encoding efficiency by using a method of at least one of arithmetic encoding or binarizing that is in accordance with the tendency.

For example, the reference three-dimensional point may be the same as the current three-dimensional point.

Accordingly, the three-dimensional data encoding device can switch the method of the at least one of arithmetic encoding or binarizing of information of the current three-dimensional point excluding the first angle, according to the first angle of the current three-dimensional point. Here, it is more likely that the tendency of the information of the current three-dimensional point is represented by the first angle of the current three-dimensional point than a first angle of a three-dimensional point other than the current three-dimensional point. Therefore, the three-dimensional data encoding method may be able to improve encoding efficiency compared to when the first angle of a three-dimensional point other than the current three-dimensional point is referred to.

For example, the reference three-dimensional point may correspond to a parent node of the current three-dimensional point, in a predictive tree of the three-dimensional points.

A predictive tree is a data structure generated according to prediction processing of a three-dimensional point. Therefore, it is highly likely that a tendency exists between the first angle of the reference three-dimensional point corresponding to a parent node and the information of the current three-dimensional point corresponding to the child node thereof. Furthermore, a three-dimensional data decoding device that decodes a bitstream generated according to the three-dimensional data encoding method can reduce the processing delay on the decoding of the first angle since the reference three-dimensional point corresponding to the parent node is decoded before the current three-dimensional point.

For example, a first scheme of the at least one of the arithmetic encoding or the binarizing may be used when the first angle is greater than a threshold, and a second scheme of the at least one of the arithmetic encoding or the binarizing may be used when the first angle is less than or equal to the threshold, the second scheme being different from the first scheme.

Accordingly, in a case where, for example, information of a three-dimensional point has a tendency that is dependent on whether the first angle is greater than a threshold, that is, a tendency that is dependent on the range the first angle, the three-dimensional data encoding method can improve encoding efficiency by using a method of at least one of arithmetic encoding or binarizing that is in accordance with the tendency.

For example, a first context used in the first scheme of the arithmetic encoding may be different from a second context used in the second scheme of the arithmetic encoding.

Accordingly, the three-dimensional data encoding method can improve encoding efficiency in a case where, for example, information of a three-dimensional point has a tendency that is dependent on the first angle, by switching contexts in accordance with the first angle.

For example, a first bit length of a binarized symbol in the first scheme of the binarizing may be different from a second bit length of a binarized symbol in the second scheme of the binarizing.

Accordingly, the three-dimensional data encoding method can improve encoding efficiency in a case where, for example, information of a three-dimensional point has a tendency that is dependent on the first angle, by switching binarized symbols in accordance with the first angle.

For example, the three-dimensional points may be encoded in ascending order of the first angles of the three-dimensional points, and when the first angle is greater than a threshold, a context of the arithmetic encoding may be initialized.

Accordingly, the three-dimensional data encoding method can use a different context when the first angle is greater than the threshold and when the first angle is less than or equal to the first angle, by initializing the context when the first angle is greater than the threshold. Consequently, the three-dimensional data encoding device can improve encoding efficiency in a case where, for example, information of a three-dimensional point has a tendency that is dependent on the first angle.

For example, the information may include at least one of the second angle, the distance, or prediction information of the current three-dimensional point.

Accordingly, the three-dimensional data encoding method can improve the encoding efficiency of at least one of the second angle, the distance, or the prediction information.

For example, the first angle may be an elevation angle and the second angle may be a horizontal angle, and the first angle may correspond to a laser ID used for generating the three-dimensional points.

Accordingly, in a case where, for example, information of a three-dimensional point has a tendency that is dependent on the range of a vertical direction position of the three-dimensional point, the three-dimensional data encoding method can improve encoding efficiency by using a method of at least one of arithmetic encoding or binarizing that is in accordance with the tendency.

A three-dimensional data decoding device according to an aspect of the present disclosure includes: a processor; and memory. Using the memory, the processor: obtains a bitstream including encoded three-dimensional points generated by encoding three-dimensional points each of which is represented by a first angle, a second angle, and a distance; determines a reference three-dimensional point among the three-dimensional points; and performs, according to the first angle of the reference three-dimensional point, at least one of arithmetic decoding or debinarizing on encoded information of a current encoded three-dimensional point included in the encoded three-dimensional points to generate information of a current three-dimensional point included in the three-dimensional points, the information excluding the first angle.

Accordingly, in a case where, for example, information of a three-dimensional point has a tendency that is dependent on the first angle, a three-dimensional data encoding device that generates a bitstream can improve encoding efficiency by using a method of at least one of arithmetic encoding or binarizing that is in accordance with the tendency. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

A three-dimensional data encoding device according to an aspect of the present disclosure includes: a processor; and memory. Using the memory, the processor: determines a reference three-dimensional point among three-dimensional points each of which is represented by a first angle, a second angle, and a distance; and performs, according to the first angle of the reference three-dimensional point, at least one of arithmetic encoding or binarizing on information of a current three-dimensional point included in the three-dimensional points, the information excluding the first angle.

Accordingly, in a case where, for example, information of a three-dimensional point has a tendency that is dependent on the first angle, a three-dimensional data encoding device that generates a bitstream can improve encoding efficiency by using a method of at least one of arithmetic encoding or binarizing that is in accordance with the tendency.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### Embodiment

First, an overview of a three-dimensional data encoding device and a three-dimensional data decoding device according to the present embodiment will be described.

A three-dimensional data encoding device according to the present embodiment switches an encoding method according to a value of a laser ID (laser_id) of a three-dimensional point when encoding geometry information of a three-dimensional point cloud in a polar coordinate system. Specifically, encoding targets for which the encoding method is switched include at least one of a prediction residual of distance d or a prediction residual of horizontal angle ϕ in the polar coordinate system. It should be noted that the encoding target may include information on various encoding modes including a prediction mode (such as intra information or inter information).

Here, the laser ID is an identifier that is assigned to each scan rotation of a laser sensor that involves rotational scanning, such as LIDAR. For example, the rotation of the rotational scanning is a rotation about an axis in the vertical direction. That is, the laser ID corresponds to elevation angle θ in the polar coordinate system, and points to which the same laser ID is assigned have substantially the same elevation angle θ. Therefore, the laser ID can be used instead of elevation angle θ. It can be said that the laser ID is a value obtained by quantizing elevation angle θ. It can also be said that the laser ID corresponds to the position (height) in the vertical direction of the three-dimensional point.

The switching of the encoding method is a switching of a binarization method, for example. Specifically, the three-dimensional data encoding device may switch the type of an exponential-Golomb code used for binarization according to the value of the laser ID.

The switching of the encoding method is a switching of a context, for example. Specifically, the three-dimensional data encoding device may prepare a context for arithmetic encoding for each value of the laser ID and switch the context to be used according to the value of the laser ID.

The laser ID used for determination of the switching may be the laser ID of a current three-dimensional point to be encoded or decoded, the laser ID of a three-dimensional point (an example of a reference three-dimensional point) that corresponds to a parent node of the current three-dimensional point, or the laser ID of a three-dimensional point (another example of the reference three-dimensional point) that corresponds to a node encoded or decoded immediately before the current three-dimensional point.

It should be noted that the reference three-dimensional point is not limited to the examples described above. The reference three-dimensional point can be any three-dimensional point that is encoded or decoded before the current three-dimensional point. Encoding or decoding of the reference three-dimensional point may be performed using intra prediction or inter prediction.

Alternatively, a threshold of the laser ID for switching of the encoding method may be prepared, and information indicating the threshold may be added to a bitstream.

Instead of switching the context, the context may be initialized. Elevation angle θ may be used instead of the laser ID. The method according to the present embodiment may be used when low-delay encoding is used.

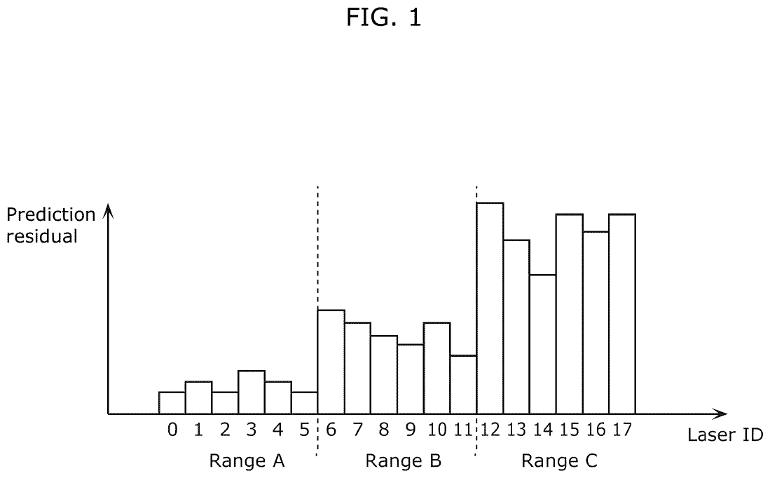

FIG. 1 is a diagram illustrating an example of a relationship between the laser ID (laser_id) and distance d or horizontal angle ϕ. In this example, the prediction residual has different tendencies between range A (laser ID=0 to 5) of the laser ID, range B (laser ID=6 to 11), and range C (laser ID=12 to 17). However, in this example, a plurality of three-dimensional points are generated by rotational scanning about a vertical axis.

For example, range A corresponds to a point cloud close to the ground. In range A, points are likely to exist at certain intervals in a point cloud having the same laser ID. Accordingly, the precision of the prediction is high, and the prediction residual is small.

Range C corresponds to a point cloud significantly above the ground. In range C, whether points exist at certain intervals depends on the object existing in the space. Therefore, points do not always exist at certain intervals in a point cloud having the same laser ID. Therefore, the precision of the prediction is low, and the prediction residual is large.

Range B is a range between range A and range C, and the prediction residual in range B has a tendency between those of ranges A and C.

As described above, the prediction residual can have different tendencies according to the value of the laser ID. Therefore, there is a possibility that the encoding efficiency can be improved by changing the processing (binarization or arithmetic encoding) on the prediction residual according to the laser ID.

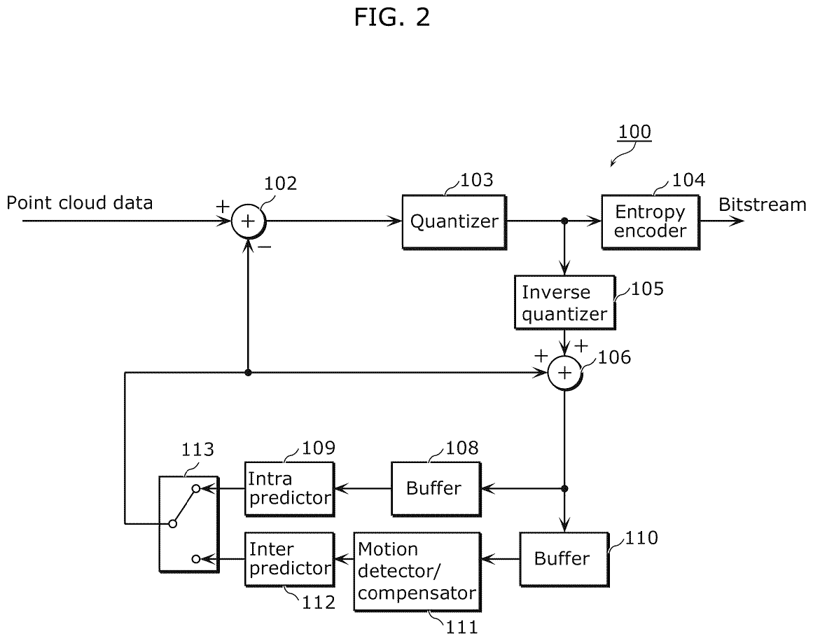

Next, configurations of a three-dimensional data encoding device and a three-dimensional data decoding device according to the present embodiment will be described. First, the overall configurations of a three-dimensional data encoding device and a three-dimensional data decoding device will be described. FIG. 2 is a block diagram illustrating the configuration of three-dimensional data encoding device 100. Three-dimensional data encoding device 100 encodes a point cloud which is three-dimensional data to thereby generate a bitstream (an encoded stream).

A point cloud, which is a set of three-dimensional points, represents the three-dimensional shape of an object. The point cloud data includes geometry information and attribute information on the three-dimensional points. The geometry information indicates the three-dimensional position of each three-dimensional point. It should be noted that the geometry information may also be called position information.

For example, geometry information is represented using a polar coordinate system and includes one distance component and two direction components (angle components). Specifically, geometry information includes distance d, elevation angle θ, and horizontal angle Φ. Point cloud data is, for example, data obtained by a laser sensor such as LiDAR, and the like. It should be noted that geometry information may be represented using an orthogonal coordinate system.

The attribute information indicates, for example, attributes such as the color, reflectance, and normal vector. One three-dimensional point may have one item of attribute information or may have a plurality of items of attribute information.

The three-dimensional data is not limited to point cloud data and may be other types of three-dimensional data, such as mesh data. Mesh data (also called three-dimensional mesh data) is a data format used for computer graphics (CG) and represents the three-dimensional shape of an object as a set of surface information items. For example, mesh data includes point cloud information (e.g., vertex information), which may be processed by techniques similar to those for point cloud data.

It should be noted that although FIG. 2 illustrates processing units related to the encoding of geometry information of point cloud data, three-dimensional data encoding device 100 may include other processing units such as processing units that perform encoding of attribute information, and so on.

Three-dimensional data encoding device 100 includes subtractor 102, quantizer 103, entropy encoder 104, inverse quantizer 105, adder 106, buffer 108, intra predictor 109, buffer 110, motion detector/compensator 111, inter predictor 112, and switcher 113.

Subtractor 102 subtracts a prediction value from geometry information included in input point cloud data to be encoded to generate a prediction residual. Quantizer 103 quantizes the prediction residual. Entropy encoder 104 entropy-encodes the quantized prediction residual to generate a bitstream. Entropy encoder 104 also entropy-encodes control information and adds the encoded information to the bitstream.

Inverse quantizer 105 inverse-quantizes the quantized prediction residual generated by quantizer 103 to generate a prediction residual. Adder 106 adds the prediction value to the prediction residual generated by inverse quantizer 105 to reproduce the geometry information. Buffer 108 retains the reproduced geometry information as a reference point cloud for intra prediction. Buffer 110 retains the reproduced geometry information as a reference point cloud for inter prediction.

It should be noted that there is a possibility that the reproduced geometry information includes a quantization error and therefore does not perfectly agree with the original geometry information. It should be noted that a three-dimensional point reproduced by encoding processing and decoding processing is referred to as an encoded three-dimensional point, a decoded three-dimensional point or a processed three-dimensional point.

Intra predictor 109 calculates a prediction value using geometry information of one or more reference points, which are other three-dimensional points belonging to the same frame as a three-dimensional point to be processed (referred to as a current point hereinafter) and are already processed. For example, intra predictor 109 performs intra prediction using a prediction tree. The prediction tree is a tree structure that indicates a reference relationship in prediction processing. For example, in prediction processing of a current node (current point), geometry information of a parent node is referred to. It should be noted that in prediction processing, geometry information of a plurality of nodes (such as a grandparent node or a great-grandparent node) including a parent node may be referred to.

Motion detector/compensator 111 detects a displacement between a current frame, which is a frame including a current point, and a reference frame, which is a frame other than the current frame, (motion detection) and corrects geometry information of a point cloud included in the reference frame based on the detected displacement (motion compensation). Information indicating the detected displacement (motion information) is stored in the bitstream, for example.

Inter predictor 112 calculates a prediction value using geometry information of one or more reference points included in a point cloud subjected to the motion compensation. It should be noted that the motion detection and the motion compensation need not be performed.

Switcher 113 selects one of the prediction value calculated by intra predictor 109 or the prediction value calculated by inter predictor 112, and outputs the selected prediction value to subtractor 102 and adder 106. That is, switcher 113 switches whether to use intra prediction or to use inter prediction.

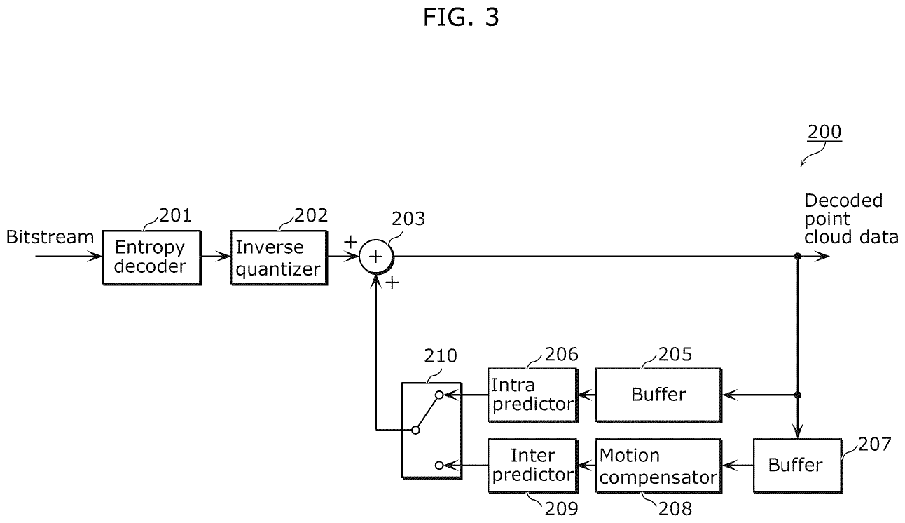

Next, a configuration of three-dimensional data decoding device 200 that decodes the bitstream generated by three-dimensional data encoding device 100 described above will be described. FIG. 3 is a block diagram of three-dimensional data decoding device 200 according to the present embodiment. It should be noted that although FIG. 3 shows a processor concerning decoding of information of a point cloud, geometry three-dimensional data decoding device 200 may include another processor, such as a processor that performs decoding or the like of attribute information of a point cloud. For example, three-dimensional data decoding device 200 generates decoded point cloud data by decoding the bitstream generated by three-dimensional data encoding device 100 shown in FIG. 1.

Three-dimensional data decoding device 200 includes entropy decoder 201, inverse quantizer 202, adder 203, buffer 205, intra predictor 206, buffer 207, motion compensator 208, inter predictor 209, and switcher 210.

Three-dimensional data decoding device 200 obtains the bitstream generated by three-dimensional data encoding device 100.

Entropy decoder 201 entropy-decodes the bitstream to generate a quantized prediction residual and control information.

Inverse quantizer 202 inverse-quantizes the quantized prediction residual generated by entropy decoder 201 to generate a prediction residual. Adder 203 adds a prediction value to the prediction residual generated by inverse quantizer 202 to reproduce the geometry information. The geometry information is output as decoded point cloud data.

Buffer 205 retains the decoded geometry information as a reference point cloud for intra prediction. Buffer 207 retains the reproduced geometry information as a reference point cloud for inter prediction. Intra predictor 206 calculates a prediction value using geometry information of one or more reference points, which are other three-dimensional points belonging to the same frame as the current point. For example, intra predictor 206 performs intra prediction using a prediction tree.

Motion compensator 208 obtains, from the bitstream, motion information indicating a displacement between a current frame and a reference frame and corrects geometry information of a point cloud included in the reference frame based on the displacement indicated by the motion information (motion compensation). Inter predictor 209 calculates a prediction value using geometry information of one or more reference points included in the point cloud subjected to the motion compensation. It should be noted that the motion compensation need not be performed.

Switcher 210 selects one of the prediction value calculated by intra predictor 206 or the prediction value calculated by inter predictor 209, and outputs the selected prediction value to adder 203.

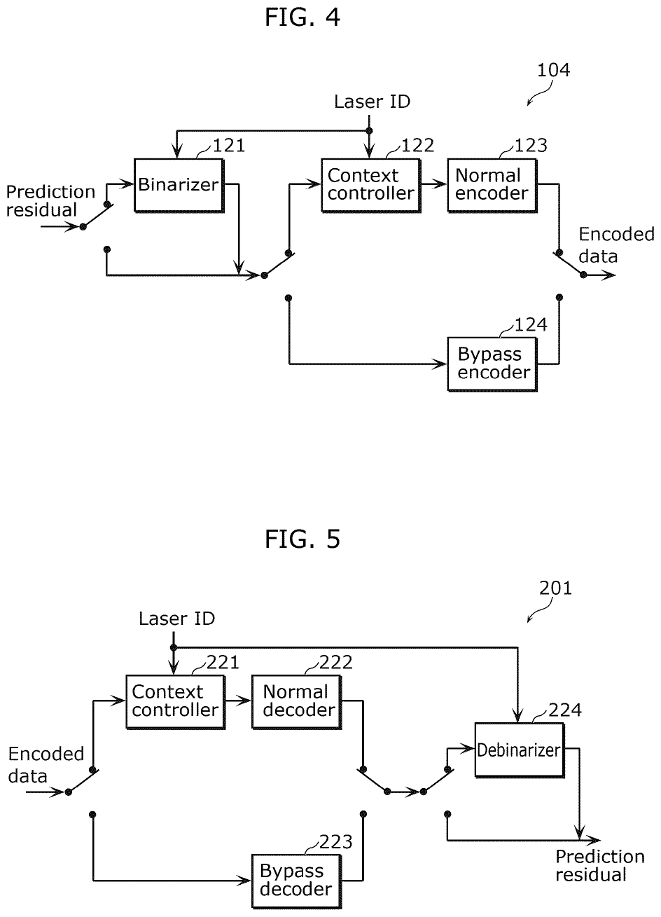

Next, configurations of entropy encoder 104 and entropy decoder 201 will be described. FIG. 4 is a block diagram illustrating a configuration of entropy encoder 104. Entropy encoder 104 includes binarizer 121, context controller 122, normal encoder 123, and bypass encoder 124.

Binarizer 121 binarizes a prediction residual. The prediction residual is a quantized prediction residual generated by quantizer 103. The prediction residual is at least one of the prediction residual of distance d or the prediction residual of horizontal angle ϕ. Binarizer 121 switches the binarization method according to the laser ID. Details of the switching of the binarization method will be described later. It should be noted that binarizer 121 may switch whether to perform binarization or not according to the laser ID instead of or in addition to switching the binarization method. Binarizer 121 may use elevation angle θ instead of or in addition to the laser ID.

Context controller 122 controls a context used for arithmetic encoding (entropy encoding). Specifically, context controller 122 selects a context used for arithmetic encoding from a plurality of contexts based on the laser ID. Details of the selection of a context will be described later.

Here, the context (probability table) indicates the appearance probability of a symbol (signal value). The probability is updated according to a processed symbol, and the updated probability is used for arithmetic encoding of a subsequent signal. Based on the probability, a correspondence relationship between an input value and an output value in the arithmetic encoding is determined.

It should be noted that context controller 122 may switch whether to perform the arithmetic encoding using the updatable context or not instead of or in addition to selecting a context. Context controller 122 may use elevation angle θ instead of or in addition to the laser ID.

Normal encoder 123 arithmetic-encodes the binarized prediction residual using the context selected by context controller 122 to generate encoded data (a bitstream).

Bypass encoder 124 arithmetic-encodes the binarized prediction residual using a context indicating a fixed probability (a context that is not updatable) to generate encoded data (a bitstream). It should be noted that whether encoding is performed by normal encoder 123 or bypass encoder 124 may be determined according to the laser ID. For example, for a signal in a range of laser IDs for which the prediction precision tends to be low (the prediction residual tends to be large), encoding by bypass encoder 124 may be selected.

FIG. 5 is a block diagram illustrating a configuration of entropy decoder 201. Entropy decoder 201 includes context controller 221, normal decoder 222, bypass decoder 223, and debinarizer 224.

Context controller 221 controls a context used for arithmetic decoding (entropy decoding). Specifically, context controller 221 selects a context used for arithmetic decoding from a plurality of contexts based on the laser ID. Details of the selection of a context will be described later.

Here, the context (probability table) indicates the appearance probability of a symbol (signal value). The probability is updated according to a processed symbol, and the updated probability is used for arithmetic decoding of a subsequent signal. Based on the probability, a correspondence relationship between an input value and an output value in the arithmetic decoding is determined.

It should be noted that context controller 221 may switch whether to perform the arithmetic decoding using the updatable context or not instead of or in addition to selecting a context. Context controller 221 may use elevation angle θ instead of or in addition to the laser ID.

Normal decoder 222 arithmetic-decodes the encoded data (bitstream) using the context selected by context controller 221 to generate a binarized prediction residual.

Bypass decoder 223 arithmetic-decodes the encoded data (bitstream) using a context indicating a fixed probability (a context that is not updatable) to generate a binarized prediction residual. It should be noted that whether decoding is performed by normal decoder 222 or bypass decoder 223 may be determined according to the laser ID. For example, for a signal in a range of laser IDs for which the prediction precision tends to be low (the prediction residual tends to be large), decoding by bypass decoder 223 may be selected.

Debinarizer 224 debinarizes (multivalues) the binarized prediction residual to generate a prediction residual. The prediction residual is a quantized prediction residual, for example, and is output to inverse quantizer 202. The prediction residual is at least one of the prediction residual of distance d or the prediction residual of horizontal angle ϕ. Debinarizer 224 switches the debinarization method (binarization method) according to the laser ID. Details of the switching of the debinarization method will be described later. It should be noted that debinarizer 224 may switch whether to perform debinarization or not according to the laser ID instead of or in addition to switching the debinarization method. Debinarizer 224 may use elevation angle θ instead of or in addition to the laser ID.

Next, specific examples of the method of switching the encoding method according to the laser ID will be described. For example, a current point cloud to be encoded is a point cloud in the polar coordinate system. It should be noted that three-dimensional data encoding device 100 may transform an input point cloud in the Cartesian coordinate system into a point cloud in the polar coordinate system and encode the resulting point cloud in the polar coordinate system. It should be noted that in the polar coordinate system, geometry information of a point is expressed as (d, ϕ, θ) using distance d from a sensor position to a current point, and horizontal angle ϕ and elevation angle θ of the current point with respect to the sensor position. The geometry information of a point may be expressed using sensor information, such as the laser ID (laser_id) of LiDAR, instead of elevation angle θ. For example, the geometry information of a point may be expressed as (d, ϕ, laser_id) using laser_id with a scan angle that is the closest to elevation angle θ instead of elevation angle θ. Here, since it can be said that laser_id is quantized elevation angle θ, the amount of information can be reduced by using laser_id instead of elevation angle θ. Therefore, the encoding efficiency can be improved.

Here, when the polar coordinates are expressed as (d, ϕ, laser_id), the values of distance d and horizontal angle ϕ may significantly vary with the value of laser_id. For example, provided that a three-dimensional point having a value of laser_id of 0 to L (L denotes a value equal to or greater than 0) represents a measurement point at the ground (referred to as three-dimensional point cloud A hereinafter), and a three-dimensional point having a value of laser_id of L+1 to M (M denotes a value equal to or greater than L+1) represents a measurement point on an object significantly above the ground (referred to as three-dimensional point cloud B hereinafter), three-dimensional point cloud A and three-dimensional point cloud B may significantly differ in the tendencies of the values of distance d and horizontal angle ϕ.

More specifically, in three-dimensional point cloud A that represents a measurement point at the ground, point clouds are likely to exist at certain intervals for the same laser_id. In addition, the values of distance d of three-dimensional points of the same laser_id are likely to be close to each other as the values of horizontal angle ϕ thereof are close to each other. Therefore, the prediction residuals of distance d and horizontal angle ϕ of the current point tend to be small if values of three-dimensional points of the same laser_id whose values of horizontal angle ϕ are close to each other are used as prediction values.

On the other hand, in three-dimensional point cloud B that represents a measurement point on an object significantly above the ground, even three-dimensional points of the same laser_id significantly vary in the values of distance d and horizontal angle ϕ depending on whether there is an object or not. Therefore, even if values of three-dimensional points of the same laser_id whose values of horizontal angle ϕ are close to each other are used as prediction values, the prediction residuals of distance d and horizontal angle ϕ of the current point may be great.

As described above, the tendency of the prediction residual of the current point may significantly vary according to the value of laser_id. Accordingly, in the present embodiment, three-dimensional data encoding device 100 switches the encoding method for the prediction residual of three-dimensional points according to the value of laser_id. For example, three-dimensional data encoding device 100 may switch the binarization method for the prediction residual of three-dimensional points according to the value of laser_id. More specifically, when laser_id of a current point corresponds to a region in which the prediction residual tends to be small, such as a scan region at the ground (first scheme), three-dimensional data encoding device 100 applies a binarization method that assigns a shorter bit length to a symbol as the prediction residual is smaller (as the prediction residual is closer to 0). When laser_id of a current point corresponds to a region in which the prediction residual tends to be large, such as a scan region significantly above the ground (second scheme), three-dimensional data encoding device 100 applies a binarization method that assigns a shorter bit length to a symbol as the prediction residual is closer to a certain prediction residual R (R denotes a numeric value greater than 0). Accordingly, when the prediction residual varies with laser_id, three-dimensional data encoding device 100 can use an appropriate binarization method, can reduce the bit length of the prediction residual after the binarization, and can improve the encoding efficiency.

As the switching of the encoding method, three-dimensional data encoding device 100 may prepare a context for arithmetic encoding of a prediction residual of a three-dimensional point for each laser_id, and switch the context to be used according to the value of laser_id. More specifically, when laser_id of a current point corresponds to a region in which the prediction residual tends to be small, such as a scan region at the ground (first scheme), three-dimensional data encoding device 100 uses context A when arithmetic-encoding the prediction residual. When laser_id of a current point corresponds to a region in which the prediction residual tends to be large, such as a scan region significantly above the ground (second scheme), three-dimensional data encoding device 100 uses context B that is different from context A when arithmetic-encoding the prediction residual. Context A is suitable for small prediction residuals. Context B is suitable for large prediction residuals. In this way, when the prediction residual varies with laser_id, three-dimensional data encoding device 100 can select an appropriate context for arithmetic encoding and can reduce the number of bits occurring after the arithmetic encoding. Accordingly, the encoding efficiency can be improved.

It should be noted that the switching of the encoding method according to the value of laser_id need not be applied to all the prediction residuals. For example, the switching of the encoding method may be applied to at least one of d or ϕ of the polar coordinates (d, laser_id). In this way, the encoding method of d or ϕ, which tends to significantly vary with the value of laser_id, can be appropriately switched, and the encoding efficiency can be improved.

It should be noted that when encoding the polar coordinates (d, ϕ, laser_id), three-dimensional data encoding device 100 may store information indicating a correspondence relationship between the value of laser_id and the value of θ in a header of the bitstream or the like. In this case, three-dimensional data decoding device 200 may transform laser_id included in the decoded polar coordinates (d, ϕ, laser_id) into θ using the above information.

The first scheme and the second scheme are not limited to the examples described above. Although the first scheme and the second scheme are defined for each of the binarization and the arithmetic encoding in the examples described above, the first scheme and the second scheme may be defined for a combination of the binarization and the arithmetic encoding.

Next, an encoding method for a prediction residual will be described. Three-dimensional data encoding device 100 uses entropy encoding to encode a prediction residual of a three-dimensional point. For example, three-dimensional data encoding device 100 divides a prediction residual into sign information (residual_sign) and an unsigned integer value. Here, the sign information is information that indicates whether the prediction residual is a positive value or a negative value. The unsigned integer value indicates the absolute value of the prediction residual. Three-dimensional data encoding device 100 binarizes each of the sign information and the unsigned integer value and applies arithmetic encoding to the resulting binarized data.

First, encoding of the sign information will be described. For example, the sign information is a 1-bit signal that assumes 0 to indicate positive and assumes 1 to indicate negative. In this case, three-dimensional data encoding device 100 selects a context suitable for the value of laser_id of the current point from a plurality of contexts, and arithmetic-encodes the sign information using the selected context. For example, one context is provided for each range of values of laser_id. Three-dimensional data encoding device 100 selects a context associated with the range that includes the value of laser_id of the current point.

As described above, by selectively using a different context according to the value of laser_id, three-dimensional data encoding device 100 can select an appropriate context even if the tendency of the value of the prediction residual varies with laser_id. Therefore, the encoding efficiency can be improved.

It should be noted that the laser_id of the current point that is used for the switching may be the laser_id of the current point before encoding or the laser_id of the current point after encoding and decoding. It should be noted that the laser_id after encoding and decoding is the laser_id included in the geometry information output by adder 106 in FIG. 2, for example. In this way, three-dimensional data decoding device 200 can switch the context according to the same laser_id after decoding as that used in three-dimensional data encoding device 100, so that three-dimensional data decoding device 200 can appropriately decode the bitstream. In this case, since the laser_id of the current point can be used, the precision of the switching can be improved.

The laser_id used for the determination of the switching may be a laser_id other than the laser_id of the current point. That is, the laser_id used for the determination of the switching may be a laser_id of a reference three-dimensional point associated with the current point.

For example, the reference three-dimensional point may be a parent node of the current point (current node) in a prediction tree. In this case, three-dimensional data decoding device 200 can obtain the laser_id of the parent node used for the determination of the switching before decoding the laser_id of the current point, so that three-dimensional data decoding device 200 can select a context for the current point before decoding the laser_id of the current point. Therefore, parallel processing is possible, and the processing speed can be increased.

Alternatively, the reference three-dimensional point may be a point before or immediately before the current point in the processing order (encoding order or decoding order). In this case, again, three-dimensional data decoding device 200 can obtain the laser_id used for the determination of the switching before decoding the laser_id of the current point, so that three-dimensional data decoding device 200 can select a context for the current point before decoding the laser_id of the current point. Therefore, parallel processing is possible, and the processing speed can be increased.

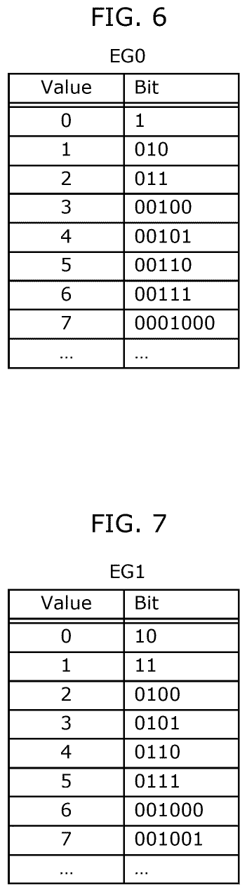

Next, an example of the method of encoding the unsigned integer value will be described. FIGS. 6, 7, and 8 are diagrams illustrating examples of exponential-Golomb codes. The tables of exponential-Golomb codes shown in FIGS. 6, 7, and 8 indicate correspondence relationships between input values (Value) and binarized data (bit) after binarization.

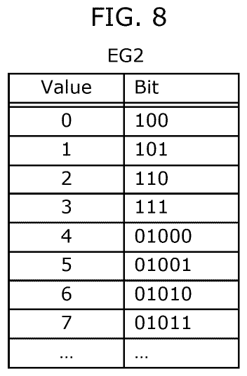

The exponential-Golomb code is formed by a prefix and a suffix, and the bit length assigned to each value varies with the bit length of the suffix assigned to a value of 0. For example, the bit length of the suffix assigned to the value of 0 is 0 in table EG0 shown in FIG. 6, the bit length of the suffix assigned to the value of 0 is 1 in table EG1 shown in FIG. 7, and the bit length of the suffix assigned to the value of 0 is 2 in table EG2 shown in FIG. 8. In this way, different bits are assigned to the same value in EG0 to EG2.

Specifically, the binarized data corresponding to the value of 0 is “1” in EG0, “10” in EG1, and “100” in EG2. Therefore, the bit length of the binarized data for the value of 0 is shorter when EG0 is used. On the other hand, the binarized data corresponding to the value of 3 is “00100” in EG0, “0101” in EG1, and “111” in EG2. Therefore, the bit length of the binarized data for the value of 3 is shorter when EG2 is used.

Accordingly, three-dimensional data encoding device 100 selects EG0 when Value tends to be small, and selects EG2 when Value tends to be large, for example. In this way, three-dimensional data encoding device 100 can reduce the code amount of the binarized data.

Three-dimensional data encoding device 100 applies the approach described above to the encoding of the unsigned integer value of the prediction residual. That is, three-dimensional data encoding device 100 switches the exponential-Golomb code to be used according to the value of laser_id. In this way, the encoding efficiency can be improved.

For example, three-dimensional data encoding device 100 may use EG(k1) (k1 denotes an integer value equal to or greater than 0) when the laser_id of the current point is equal to or smaller than a value of L, and use EG(k2) (k2 denotes an integer value that satisfies k2>k1) when the laser_id is greater than the value of L. In this way, three-dimensional data encoding device 100 can binarize the prediction residual by using EG(k1) when encoding three-dimensional point cloud A for which the prediction residual tends to be small and using EG(k2) when encoding three-dimensional point cloud B for which the prediction residual tends to be large. Accordingly, three-dimensional data encoding device 100 can adaptively reduce the bit length of the binarized data and can improve the encoding efficiency.

In addition, three-dimensional data encoding device 100 switches the context to be used for arithmetic encoding of the binarized data according to the value of laser_id. Here, one or more contexts to be switched may be provided for each range of values of laser_id. That is, three-dimensional data encoding device 100 may switch a context group to be used for arithmetic encoding of the binarized data according to the value of laser_id. Here, the context group may include a context for the prefix and a context for the suffix. Alternatively, the context group may include a plurality of contexts provided for each bit of the prefix and the suffix.

For example, when the laser_id of the current point is equal to or smaller than the value of L, three-dimensional data encoding device 100 selects, from context group C, a context for each bit of the prefix and the suffix included in the binarized data, and arithmetic-encodes each bit using the context for the bit. When the laser_id is greater than the value of L, three-dimensional data encoding device 100 selects, from context group D, a context for each bit of the prefix and the suffix included in the binarized data. In this way, three-dimensional data encoding device 100 can appropriately select a context even when the prediction residual varies with laser_id and therefore can improve the encoding efficiency.

It should be noted that as the exponential-Golomb codes, codes with 0 and 1 of the prefix and suffix shown in FIGS. 6, 7, and 8 inverted may be used. The exponential-Golomb codes shown in FIGS. 6, 7, and 8 are examples, and other exponential-Golomb codes can also be used.

Three-dimensional data encoding device 100 may store, in the bitstream, information indicating the table of exponential-Golomb codes (exponential-Golomb codes used for binarization) or the scheme selected according to laser_id.

As with three-dimensional data encoding device 100, three-dimensional data decoding device 200 also selects a table of exponential-Golomb codes or selects a contact or a context group according to laser_id. It should be noted that three-dimensional data decoding device 200 performs arithmetic decoding using the selected context and performs debinarization according to the selected exponential-Golomb codes. It should be noted that when the bitstream includes information indicating the table of exponential-Golomb codes used for binarization, three-dimensional data decoding device 200 may select the table of exponential-Golomb codes used for debinarization based on the information.

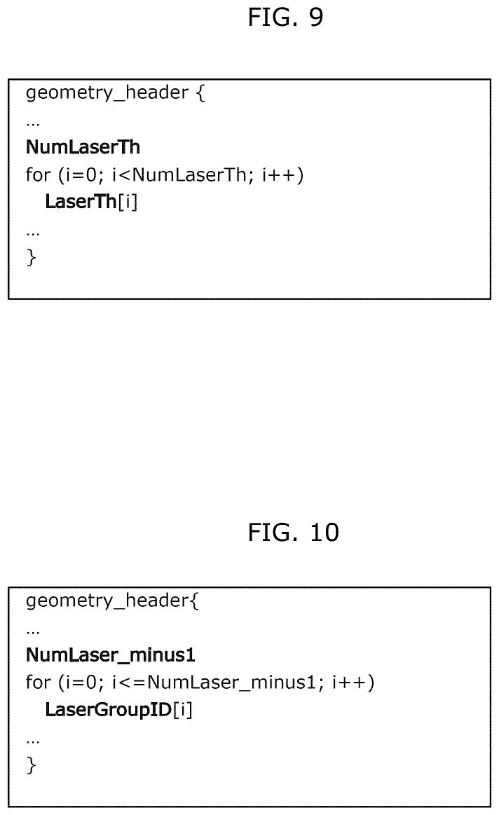

Next, an example of a syntax of a signal concerning the processing described above included in the encoded data (bitstream) will be described. FIG. 9 is a diagram illustrating an example of a syntax of a header (geometry_header) of encoded geometry information. The header of geometry information shown in FIG. 9 includes NumLaserTh and LaserTh[i].

NumLaserTh indicates the number of LaserTHs, which are thresholds for switching of the encoding method according to the value of laser_id. It should be noted that when three-dimensional data encoding device 100 does not use the switching processing for the encoding method according to laser_id, three-dimensional data encoding device 100 may add NumLaserTH of 0 to the bitstream and need not add LaserTh to the bitstream. In this way, the code amount of the header can be reduced. When NumLaserTH=0, three-dimensional data decoding device 200 need not use the switching processing for the decoding method according to laser_id. Alternatively, three-dimensional data decoding device 200 may estimate the value of the threshold LaserTh[0] to be 0. In this way, three-dimensional data decoding device 200 can appropriately decode the bitstream without switching the decoding method according to laser_id.

LaserTh[i] indicates an i-th threshold for switching the encoding method according to the value of laser_id. Using the threshold, at least one of the switching of the binarization method (debinarization method) of the prediction residual or switching of the context for arithmetic encoding (arithmetic decoding) is performed. For example, when NumLaserTh=2, three-dimensional data encoding device 100 performs the arithmetic encoding using context A if the laser_id of the current point is smaller than LaserTh[0]. If the laser_id is equal to or greater than the threshold LaserTh[0] and smaller than LaserTh[1], three-dimensional data encoding device 100 performs the arithmetic encoding using context B. If the laser_id is equal to or greater than the threshold LaserTh[1], three-dimensional data encoding device 100 performs the arithmetic encoding using context C. In this way, three-dimensional data encoding device 100 can select an appropriate context according to laser_id and therefore can improve the encoding efficiency. It should be noted that as the information indicating LaserTh[i+1], information indicating the difference between LaserTh[i] and LaserTh[i+1] may be stored in the bitstream. In this way, the code amount of the header can be reduced.

FIG. 10 is a diagram illustrating another example of the syntax of the header (geometry_header) of encoded geometry information. The header of geometry information shown in FIG. 10 includes NumLaser_minus1 and LaserGroupID[i].

NumLaser_minus1 indicates NumLaser, which is the number of laser_ids included in the bitstream. In other words, NumLaser indicates the number of possible values of laser_id. Specifically, NumLaser_minus1 indicates a value obtained by subtracting 1 from NumLaser. That is, using NumLaser_minus1, for example, NumLaser is expressed as NumLaser=NumLaser_minus1+1.

LaserGroupID[i] is information for identifying a group of laser_ids. For example, LaserGroupID[i] indicates the number of a group to which an i-th laser_id belongs. Specifically, when NumLaser_minus1=3, for example, laser_id is any of 0, 1, 2, and 3. In this case, when LaserGroupID[0]=0, LaserGroupID[1]=0, LaserGroupID[2]=1, and LaserGroupID[3]=2, laser_ids of 0 and 1 belong to group 0, laser_id of 1 belongs to group 1, and laser_id of 2 belongs to group 2.

In this case, three-dimensional data encoding device 100 identifies a group based on the value of the laser_id of the current point, and performs at least any one of the switching of the binarization method of the prediction residual or the switching of the context for arithmetic encoding according to the identified group. For example, concerning the switching of the context for arithmetic encoding, when the laser_id of the current point belongs to group 0, three-dimensional data encoding device 100 performs the arithmetic encoding using context A. When the laser_id of the current point belongs to group 1, three-dimensional data encoding device 100 performs the arithmetic encoding using context B. When the laser_id of the current point belongs to group 2, three-dimensional data encoding device 100 performs the arithmetic encoding using context C. In this way, three-dimensional data encoding device 100 can select an appropriate context according to the group to which the laser_id belongs, and therefore can improve the encoding efficiency.

It should be noted that when three-dimensional data encoding device 100 does not use the switching processing for the encoding method according to laser_id, three-dimensional data encoding device 100 may add NumLaser_minus1 of 0 to the bitstream and need not add LaserGroupID to the bitstream. In this way, the code amount of the header can be reduced. When NumLaser_minus1=0, three-dimensional data decoding device 200 need not use the switching processing for the decoding method according to laser_id. Alternatively, three-dimensional data decoding device 200 may estimate the value of LaserGroupID[0] to be 0. In this way, three-dimensional data decoding device 200 can appropriately decode the bitstream without switching the decoding method according to laser_id.

Three-dimensional data encoding device 100 may add at least one of NumLaserTh, LaserTH[i], NumLaser_minus1, or LaserGroupID[i] to the header after entropy-encoding the value. For example, three-dimensional data encoding device 100 may arithmetic-encode each value after binarizing the value. Alternatively, in order to reduce the processing amount, three-dimensional data encoding device 100 may encode these signals with a fixed length.

It should be noted that the header of geometry information shown in FIG. 9 or 10 may further include information indicating the table of exponential-Golomb codes (exponential-Golomb codes used for binarization) or the scheme selected according to laser_id.

FIG. 11 is a flowchart of switching processing of the encoding method using the syntax shown in FIG. 9. Three-dimensional data encoding device 100 first determines whether the laser_id of the current point is smaller than LaserTH[0] (S101).

When the laser_id is smaller than LaserTH[0] (Yes in S101), three-dimensional data encoding device 100 binarizes the prediction residuals of distance d and horizontal angle ϕ of the current point using binarization method A, and arithmetic-encodes each bit of the resulting binarized data using context A (S102).

On the other hand, when the laser_id is equal to or greater than LaserTH[0] (No in S101), three-dimensional data encoding device 100 binarizes the prediction residuals of distance d and horizontal angle ϕ of the current point using binarization method B, and arithmetic-encodes each bit of the resulting binarized data using context B (S103). Here, binarization method B is different from binarization method A, and context B is different from context A.

It should be noted that although an example in which switching is applied to both the prediction residuals of distance d and horizontal angle ϕ is shown here, switching may be applied to only one of the prediction residuals of distance d or horizontal angle ϕ. Although an example in which switching is applied to both the binarization method and the context is shown here, switching may be applied to only one of the binarization method or the context.

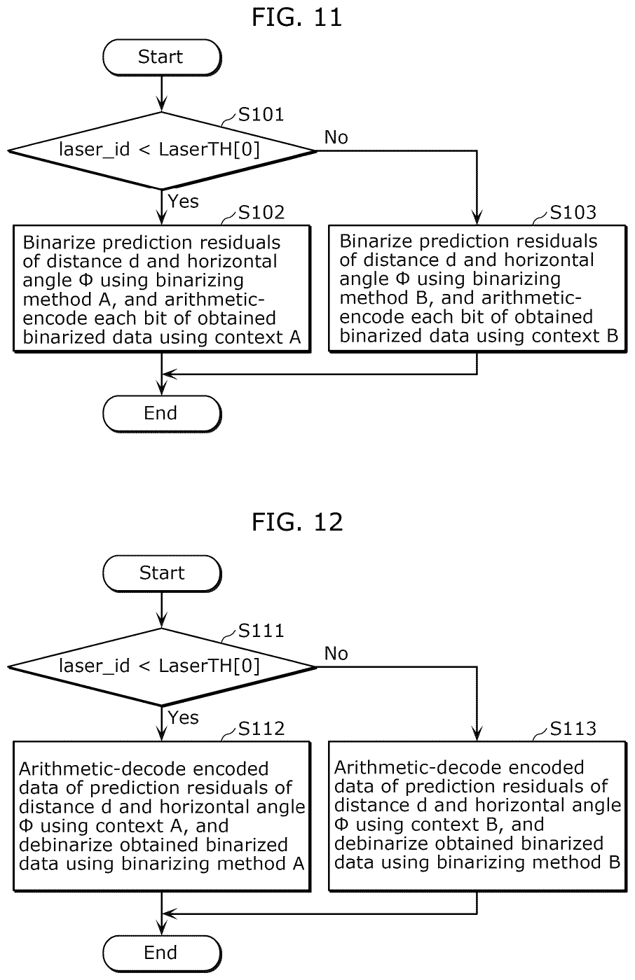

FIG. 12 is a flowchart of switching processing of the decoding method using the syntax shown in FIG. 9. Three-dimensional data decoding device 200 first determines whether the laser_id is smaller than LaserTH[0] (S111).

When the laser_id is smaller than LaserTH[0] (Yes in S111), three-dimensional data decoding device 200 arithmetic-decodes the encoded data of the prediction residuals of distance d and horizontal angle ϕ of the current point using context A, and debinarizes the resulting binarized data using binarization method A (debinarization method A) to decode the prediction residuals (S112).

On the other hand, when the laser_id is equal to or greater than LaserTH[0] (No in S111), three-dimensional data decoding device 200 arithmetic-decodes the encoded data of the prediction residuals of distance d and horizontal angle ϕ of the current point using context B, and debinarizes the resulting binarized data using binarization method B (debinarization method B) to decode the prediction residuals (S113). Here, binarization method B is different from binarization method A, and context B is different from context A.

It should be noted that although an example in which switching is applied to both the prediction residuals of distance d and horizontal angle ϕ is shown here, switching may be applied to only one of the prediction residuals of distance d or horizontal angle ϕ. Although an example in which switching is applied to both the binarization method and the context is shown here, switching may be applied to only one of the binarization method or the context.

Although an example in which switching of the binarization method (debinarization method) and the context is applied to the encoding and decoding of the prediction residuals of distance d and horizontal angle ϕ has been described above, the switching may be applied to the encoding and decoding of other signals (such as prediction information) included in the encoded data of the geometry information described below.

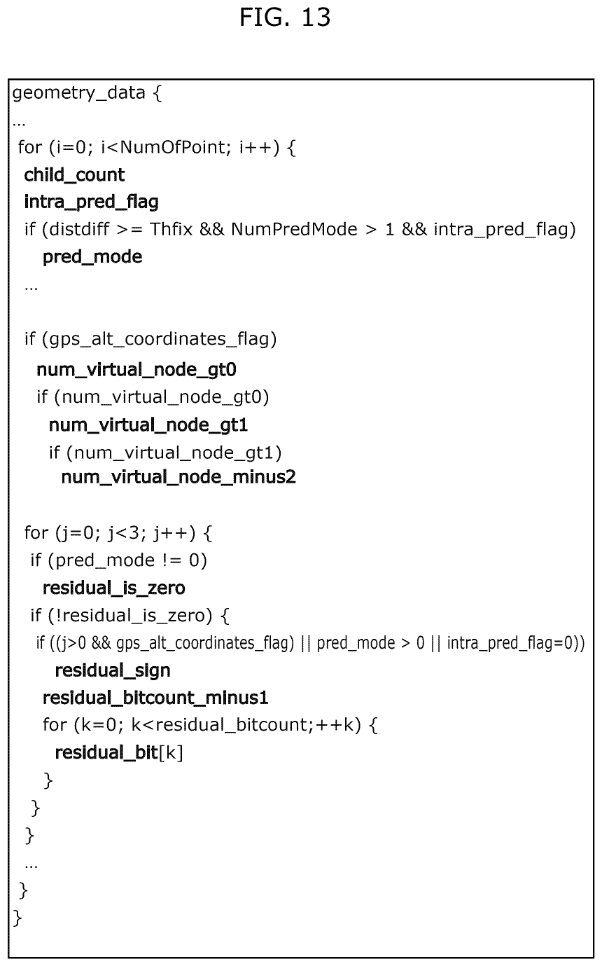

FIG. 13 is a diagram illustrating an example of a syntax of encoded data (geometry_data) of geometry information. The encoded data of geometry information includes child_count, intra_pred_flag, pred_mode, num_virtual_node_gt0, num_virtual_node_gt1, num_virtual_node_minus2, residual_is_zero, residual_sign, residual_bitcount_minus1, and residual_bit[k]. These signals are provided for each three-dimensional point.

child_count indicates the number of child nodes of an i-th three-dimensional point (node[i]).

intra_pred_flag indicates whether the prediction method for a current point to be encoded or decoded is the intra prediction or not (that is, whether the prediction method is the intra prediction or the inter prediction).

pred_mode indicates a prediction mode for encoding or decoding geometry information of the i-th three-dimensional point. pred_mode assumes values from 0 to M−1 (M denotes the total number of prediction modes). When pred_mode is not included in the bitstream (when a condition that distdiff>=Thfix[i] && NumPredMode>1 && intra_pred_flag is not satisfied), pred_mode may be estimated to be a value of α. Here, Thfix[i] is a threshold for determining whether to fix the prediction mode or not. distdiff is the absolute value of the difference between distance do between point p1 and point p0 used for prediction and distance d1 between point p1 and point p2 used for prediction. Points p0, p1, and p2 are a parent node, a grandparent node, and a great-grandparent node of the current point (current node), respectively. NumPredMode indicates the total number M of the prediction modes used for prediction of the geometry information.

α indicates a prediction mode for calculating a prediction value using linear prediction and is 2, for example. It should be noted that a is not limited to the value of 2 and can be any value from 0 to M−1. When pred_mode is not included in the bitstream, an estimation value may be added to the header or the like. Three-dimensional data encoding device 100 may arithmetic-encodes pred_mode after binarizing pred_mode with a truncated unary code using the number of the prediction modes to which a prediction value is assigned.

It should be noted that when intra_pred_flag=0, that is, when the inter prediction is used, three-dimensional data encoding device 100 need not add pred_mode to the bitstream. In this way, the code amount can be reduced. In this case, three-dimensional data decoding device 200 may estimate pred_mode to be the value of α (α=0, for example). It should be noted that a is not limited to the value of 0 and can be any value from 0 to M−1. When pred_mode is not included in the bitstream, an estimation value may be added to the header or the like.

num_virtual_node_gt0, num_virtual_node_gt1, and num_virtual_node_minus2 are information that indicates num_virtual_node.

num_virtual_node indicates the number of virtual nodes of the i-th three-dimensional point. The virtual node is an imaginary node (point) used for prediction, and may be one or more points imaginarily arranged based on intervals between a plurality of points that exist, for example. Three-dimensional data encoding device 100 and three-dimensional data decoding device 200 may correct a prediction value calculated in the pred_mode using the value of num_virtual_node.

It should be noted that when pred_mode=0 (when no prediction occurs, for example), three-dimensional data encoding device 100 need not add num_virtual_node to the bitstream. In this way, the code amount can be reduced when pred_mode=0. When num_virtual_node is not added to the bitstream, three-dimensional data decoding device 200 may estimate the value of num_virtual_node to be 0. In this way, three-dimensional data decoding device 200 can appropriately decode the bitstream.

When a coordinate system other than the Cartesian coordinate system, such as the polar coordinate system, is used in the encoding or decoding processing for a point cloud (when gps_alt_coordinates_flag=1), three-dimensional data encoding device 100 adds num_virtual_node to the bitstream. When the Cartesian coordinate system is used in the encoding or decoding processing for a point cloud (when gps_alt_coordinates_flag=0), three-dimensional data encoding device 100 need not add num_virtual_node to the bitstream. In this way, when encoding geometry information in the polar coordinate system, three-dimensional data encoding device can improve the encoding efficiency by using num_virtual_node. When encoding geometry information in the Cartesian coordinate system, three-dimensional data encoding device 100 can reduce the code amount by not adding num_virtual_node to the bitstream.

It should be noted that gps_alt_coordinates_flag indicates whether the encoding or decoding processing for a point cloud is performed in the Cartesian coordinate system (a value of 0) or performed in a coordinate system other than the Cartesian coordinate system (such as the polar coordinate system) (a value of 1). gps_alt_coordinates_flag is added to the bitstream.

num_virtual_node is expressed as num_virtual_node=num_virtual_node_gt0+num_virtual_node_gt1+num_virtual_node_minus2 using num_virtual_node_gt0, num_virtual_node_gt1, and num_virtual_node_minus2, for example.

Here, num_virtual_node_gt0 indicates whether num_virtual_node is greater than 0 or not. For example, a value of 0 indicates that num_virtual_node is equal to 0, and a value of 1 indicates that num_virtual_node is greater than 0. It should be noted that when num_virtual_node_gt0 is not added to the bitstream, three-dimensional data decoding device 200 may estimate num_virtual_node_gt0 to be 0.

num_virtual_node_gt1 indicates whether num_virtual_node is greater than 1 or not. For example, a value of 0 indicates that num_virtual_node is equal to 1, and a value of 1 indicates that num_virtual_node is greater than 1. It should be noted that when num_virtual_node_gt1 is added not to the bitstream, three-dimensional data decoding device 200 may estimate num_virtual_node_gt1 to be 0.

num_virtual_node_minus2 indicates a value obtained by subtracting 2 from the value of num_virtual_node. For example, a value of 0 indicates that the number indicated by num_virtual_node is 2, and a value of 1 indicates that the number indicated by It should be noted that when num_virtual_node is 3. num_virtual_node_minus2 is not added to the bitstream, three-dimensional data decoding device 200 may estimate num_virtual_node_minus2 to be 0.

residual_is_zero, residual_sign, residual_bitcount_minus1, and residual_bit[k] are information that indicates residual_value, which is a residual of geometry information of a three-dimensional point.

residual_is_zero indicates whether residual_value is 0 or not. For example, a value of 1 indicates that residual_value=0, and a value of 0 indicates that residual_value is not 0. It should be noted that when pred_mode=0 (when no prediction occurs or the prediction value is 0, for example), the value of residual_value is unlikely to be 0, so that three-dimensional data encoding device 100 need not add residual_is_zero to the bitstream. When pred_mode=0, three-dimensional data decoding device 200 may estimate that residual_is_zero to be 0, rather than decoding residual_is_zero from the bitstream.

residual_sign is a sign bit that indicates whether residual_value is positive or negative. For example, a value of 1 indicates that the value of residual_value is negative, and a value of 0 indicates that the value of residual_value is positive. It should be noted that as shown in FIG. 13, when condition 1 that ((j>0 && gps_alt_coordinates_flag)∥pred_mode>0∥intra_pred_flag=0) is not satisfied, residual_value is a positive value so that three-dimensional data encoding device 100 need not add residual_sign to the bitstream. When condition 1 is not satisfied, three-dimensional data decoding device 200 may estimate residual_sign to be 0, rather than decoding residual_sign from the bitstream.

Here, j denotes one element in geometry information. For example, when gps_alt_coordinates_flag=1 (when the coordinate system is the polar coordinate system), j=0 indicates the distance (radius), j=1 indicates horizontal angle ϕ, and j=2 indicates elevation angle θ.

It should be noted that when a condition that (j>0 && gps_alt_coordinates_flag) is satisfied, that is, when the coordinate system is the polar coordinate system, and the element of geometry information is ϕ or 0, the residual can be negative. Therefore, it is possible that three-dimensional data encoding device 100 adds residual_sign to the bitstream when condition 1 described above is satisfied, and does not add residual_sign to the bitstream when condition 1 is not satisfied. In this way, the code amount can be reduced.

When intra_pred_flag=0, that is, when the inter prediction is used, the residuals of all the elements of geometry information can be negative. Therefore, it is possible that three-dimensional data encoding device 100 adds residual_sign to the bitstream when condition 1 described above is satisfied, and does not add residual_sign to the bitstream when condition 1 is not satisfied. In this way, the code amount can be reduced.

When pred_mode=0 (when no prediction occurs, the prediction value is 0, or the prediction residual is equal to or greater than 0 since a prediction value added to the header is used, for example), the value of residual_value is positive. Therefore, when condition 1 is not satisfied, three-dimensional data encoding device 100 need not encode residual_sign and add residual_sign to the bitstream. It should be noted that when residual_sign is not added to the bitstream, three-dimensional data decoding device 200 may estimate residual_sign to be 0, rather than decoding residual_sign from the bitstream.

residual_bitcount_minus1 indicates a value obtained by subtracting 1 from the number of bits indicated by residual_bit. That is, residual_bitcount=residual_bitcount_minus1+1.

residual_bit[k] indicates a value of a k-th bit of the absolute value of residual_value binarized with a fixed length according to the value of residual_bitcount.

Three-dimensional data encoding device 100 entropy-encodes at least one of the items of information described above including child_count, intra_pred_flag, pred_mode, num_virtual_node_gt0, num_virtual_node_gt1, num_virtual_node_minus2, residual_is_zero, residual_sign, residual_bitcount_minus1, and residual_bit and adds the entropy-encoded information to the header. For example, three-dimensional data encoding device 100 arithmetic-encodes each value after binarizing the value.

It should be noted that in the binarization or arithmetic encoding of these signals, the switching of the binarization method or switching of the context according to laser_id described above may be applied. In this way, the encoding efficiency can be improved. That is, the switching of the binarization method or switching of the context according to laser_id described above may be applied to information indicating the prediction residual (for example, residual_is_zero, residual_sign, residual_bitcount_minus1, or residual_bit), or may be applied to prediction information concerning the prediction (for example, child_count, intra_pred_flag, pred_mode, num_virtual_node_gt0, num_virtual_node_gt1, or num_virtual_node_minus2).

In the following, variations of the present embodiment will be described. Although an example in which the current point is expressed by polar coordinates (d, ϕ, laser_id) is shown in the embodiment described above, the present disclosure is not limited to this, and the current point may be expressed by polar coordinates (d, ϕ, θ), for example. Here, d denotes the distance from the sensor position to the current point, ϕ denotes the horizontal angle of the current point with respect to the sensor position, and θ denotes the elevation angle of the current point with respect to the sensor position. That is, elevation angle θ may be used instead of laser_id. In that case, the switching of the encoding method for encoded information such as a prediction residual or prediction mode of a three-dimensional point described above may be performed according to the value of θ instead of laser_id. For example, three-dimensional data encoding device 100 may switch the binarization method for the prediction residual of a three-dimensional point according to the value of θ. Three-dimensional data encoding device 100 may also prepare a context for arithmetic encoding of the prediction residual of a three-dimensional point on a θ basis, and switch the context to be used according to the value of θ. In this way, the encoding efficiency can be improved while reducing the processing amount of the calculation of laser_id from θ.

Furthermore, although an example in which when arithmetic-encoding encoded information such as a prediction residual or prediction mode of a three-dimensional point, a context is prepared for each laser_id, and the context to be used is switched according to the value of laser_id is shown in the embodiment described above, the present disclosure is not limited to this. For example, three-dimensional data encoding device 100 may initialize the context to be used for arithmetic encoding when the value of the laser_id of the current point is different from the value of the laser_id of the three-dimensional point encoded immediately before the current point. In this case, three-dimensional data encoding device 100 geometry of encodes information of a plurality three-dimensional points in ascending or descending order of laser_id, for example. Three-dimensional data encoding device 100 initializes the context when a change of laser_id causes a change of characteristics of the prediction residual or prediction mode. Therefore, three-dimensional data encoding device 100 can use a context that is not affected by the characteristics before the change of characteristics for encoding of information after the change of characteristics, and therefore can improve the encoding efficiency.

Furthermore, the method shown in the present embodiment can be applied whether horizontal angle ϕ or elevation angle θ (or laser_id) is assigned higher priority in scanning and encoding (or decoding) processing. The scanning here is scanning of points in the encoding (in processing order) and is not the scanning of laser measurement. That is, the method shown in the present embodiment may be applied to a case where the processing is performed in ascending order (or descending order) of elevation angle θ or a case where the processing is performed in ascending order (or descending order) of horizontal angle ϕ. In other words, in the former case, a plurality of point clouds are processed in ascending order (or descending order) of elevation angle θ in units of a point cloud having a corresponding (the same or similar) elevation angle θ, and in the processing of each point cloud, a plurality of points included in the point cloud are processed in ascending order (or descending order) of horizontal angle ϕ. In the latter case, a plurality of point clouds are processed in ascending order (or descending order) of horizontal angle ϕ in units of a point cloud having a corresponding (the same or similar) horizontal angle ϕ, and in the processing of each point cloud, a plurality of points included in the point cloud are processed in ascending order (or descending order) of elevation angle θ. That is, in the latter case, scanning in the vertical direction with respect to the ground is first performed at a certain horizontal angle, scanning in the vertical direction is then performed at a different horizontal angle, and this procedure is repeated. When the latter approach is adopted, in particular, the value of elevation angle θ (or laser_id) can significantly vary with the point being processed. Therefore, there is a possibility that the encoding method cannot be appropriately switched by the processing of switching the encoding method for each group in the processing order. On the other hand, when the method according to the present embodiment is used, the encoding method can be switched according to the value of elevation angle θ or laser_id regardless of the processing order, and therefore, the encoding method can be appropriately selected.

Furthermore, three-dimensional data encoding device 100 may determine LaserTH described above by using the value of elevation angle θ in the calculation of laser_id, for example. For example, provided that the angle parallel to the ground is an elevation angle of 0 degrees, three-dimensional data encoding device 100 sets laser_id corresponding to e close to the elevation angle of 0 degrees as laser_id_theta0, and sets the value of laser_id_theta0 as LaserTH. In this case, when laser_id is smaller than laser_id_theta0, that is, when the elevation angle is smaller than 0 degrees (a negative value), a three-dimensional point cloud in a ground region is scanned, and when laser_id is equal to or greater than laser_id_theta0, that is, when the elevation angle is equal to or greater than 0 degrees, a three-dimensional point cloud in a region above the ground is scanned. In this way, three-dimensional data encoding device 100 can apply, according to the value of laser_id, an appropriate encoding method to each of a three-dimensional point cloud in a ground region and a three-dimensional point cloud in a region above the ground, and therefore can improve the encoding efficiency.

Furthermore, three-dimensional data encoding device 100 may identifies ground region A and above-ground region B from an input three-dimensional point cloud by applying recognition processing or the like in advance, set laser_id for scanning of region A as LaserGroupID[0], and set laser_id for scanning of region B as LaserGroupID[1]. Then, three-dimensional data encoding device 100 switches the encoding method according to the LaserGroupID to which the laser_id of the current point belongs. In this way, three-dimensional data encoding device 100 can select an encoding method appropriate for the characteristics of the region to which the laser_id belongs, and therefore can improve the encoding efficiency.

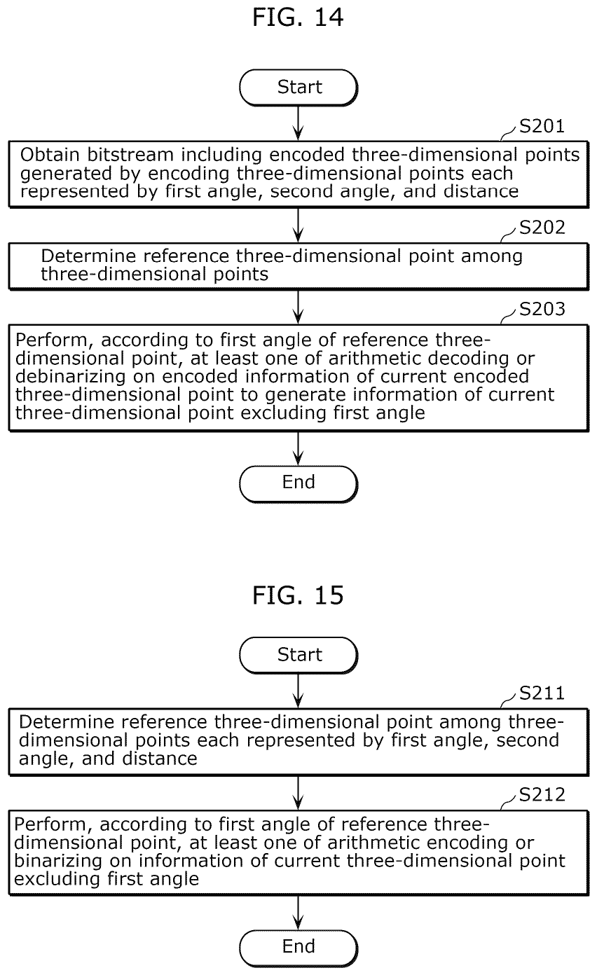

As described above, the three-dimensional data decoding device according to the present embodiment performs the process illustrated in FIG. 14. The three-dimensional data decoding device obtains a bitstream including encoded three-dimensional points generated by encoding three-dimensional points each of which is represented by a first angle, a second angle, and a distance (S201). For example, geometry information of the three-dimensional points is represented by polar coordinates.

The three-dimensional data decoding device determines a reference three-dimensional point among the three-dimensional points (S202), and performs, according to the first angle of the reference three-dimensional point, at least one of arithmetic decoding or debinarizing on encoded information of a current encoded three-dimensional point included in the encoded three-dimensional points to generate information of a current three-dimensional point included in the three-dimensional points, the information excluding the first angle (S203).

Accordingly, in a case where, for example, information of a three-dimensional point has a tendency that is dependent on the first angle, a three-dimensional data encoding device that generates a bitstream can improve encoding efficiency by using a method (aspect) of at least one of arithmetic encoding or binarizing that is in accordance with the tendency. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

It should be noted that a tendency that is dependent on the first angle includes, for example, a relationship in which the value of information to be encoded is bigger as the first angle is bigger, a relationship in which the value of information to be encoded is smaller as the first angle is bigger, a relationship in which the range of the value of information to be encoded is restricted when the first angle is substantially equal to a predetermined value, and so on. In other words, a tendency that is dependent on the first angle is a tendency in which the value of information to be encoded is identified from the first angle.

For example, the reference three-dimensional point is the same as the current three-dimensional point. Accordingly, a three-dimensional data encoding device that generates a bitstream can switch the method of the at least one of arithmetic decoding or debinarizing of information of the current three-dimensional point excluding the first angle, according to the first angle of the current three-dimensional point. Specifically, in this aspect, the information excluding the first angle is decoded after the first angle, according to the first angle that is decoded before the current three-dimensional point. Here, it is more likely that the tendency of the information of the current three-dimensional point is represented by the first angle of the current three-dimensional point than a first angle of a three-dimensional point other than the current three-dimensional point. Therefore, the three-dimensional data encoding device may be able to improve encoding efficiency compared to when the first angle of a three-dimensional point other than the current three-dimensional point is referred to. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

For example, the reference three-dimensional point corresponds to a parent node of the current three-dimensional point, in a predictive tree of the three-dimensional points. Specifically, the reference three-dimensional point may be a three-dimensional point other than the current three-dimensional point. Furthermore, the reference three-dimensional point may be a decoded point. For example, the reference three-dimensional three-dimensional point may be the three-dimensional point immediately before the current three-dimensional point in decoding order (encoding order).

A predictive tree is a data structure generated according to prediction processing of a three-dimensional point. Therefore, it is highly likely that a tendency exists between the first angle of the reference three-dimensional point corresponding to a parent node and the information of the current three-dimensional point corresponding to the child node thereof. Furthermore, the three-dimensional data decoding device can reduce the processing delay on the decoding of the first angle since the reference three-dimensional point corresponding to the parent node is decoded before the current three-dimensional point.

For example, a first scheme of the at least one of the arithmetic decoding or the debinarizing is used when the first angle is greater than a threshold, and a second scheme of the at least one of the arithmetic decoding or the debinarizing is used when the first angle is less than or equal to the threshold, the second scheme being different from the first scheme.

Accordingly, in a case where, for example, information of a three-dimensional point has a tendency that is dependent on whether the first angle is greater than a threshold, that is, a tendency that is dependent on the range the first angle, a three-dimensional data encoding device that generates a bitstream can improve encoding efficiency by using a method of at least one of arithmetic encoding or binarizing that is in accordance with the tendency. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

For example, a first context used in the first scheme of the arithmetic decoding is different from a second context used in the second scheme of the arithmetic decoding. It should be noted that a plurality of contexts may be used in each scheme. In other words, a first context group may used in the first scheme of the arithmetic decoding, and a second context group different from the first context group may be used in the second scheme of the arithmetic decoding.

Accordingly, a three-dimensional data encoding device that generates a bitstream can improve encoding efficiency in a case where, for example, information of a three-dimensional point has a tendency that is dependent on the first angle, by switching contexts in accordance with the first angle. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

For example, a first bit length of a binarized symbol in the first scheme of the debinarizing is different from a second bit length of a binarized symbol in the second scheme of the debinarizing. Specifically, a first binarization table to be used in the first scheme and indicating the relationship between a value before transforming and a binarized symbol after transforming, may be different from a second binarization table to be used in the second scheme.

Accordingly, a three-dimensional data encoding device that generates a bitstream can improve encoding efficiency in a case where, for example, information of a three-dimensional point has a tendency that is dependent on the first angle, by switching binarized symbols in accordance with the first angle. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

For example, the encoded three-dimensional points are decoded in ascending order of the first angles of the three-dimensional points, and when the first angle is greater than a threshold, a context of the arithmetic decoding is initialized. It should be noted that it is also acceptable that the encoded three-dimensional points are decoded in descending order of the first angles of the three-dimensional points, and when the first angle is less than the threshold, the context of the arithmetic decoding is initialized.

Accordingly, a three-dimensional data encoding device that generates a bitstream can use a different context when the first angle is greater than the threshold and when the first angle is less than or equal to the first angle, by initializing the context when the first angle is greater than the threshold. Consequently, the three-dimensional data encoding device can improve encoding efficiency in a case where, for example, information of a three-dimensional point has a tendency that is dependent on the first angle. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

For example, the information includes at least one of the second angle, the distance, or prediction information of the current three-dimensional point. It should be noted that prediction information is information indicating details of the prediction processing of at least part of the geometry information (first angle, second angle, distance) of the current three-dimensional point. Moreover, prediction information may include information on inter prediction, and may include information on intra prediction. For example, as illustrated in FIG. 13, prediction information may include at least one of child_count, intra_pred_flag, pred_mode, num_virtual_node_gt0, num_virtual_node_gt1, or num_virtual_node_minus2

Accordingly, the three-dimensional data decoding device can appropriately decode a bitstream for which encoding efficiency of at least one of the second angle, the distance, or the prediction information has been improved.

For example, the first angle is an elevation angle and the second angle is a horizontal angle, and the first angle corresponds to a laser ID used for generating the three-dimensional points.

Accordingly, in a case where, for example, information of a three-dimensional point has a tendency that is dependent on the range of a vertical direction position of the three-dimensional point, or the like, a three-dimensional data encoding device that generates a bitstream can improve encoding efficiency by using a method of at least one of arithmetic encoding or binarizing that is in accordance with the tendency. The three-dimensional data decoding device can appropriately decode the bitstream for which the encoding efficiency has been improved. Furthermore, by improving the encoding efficiency of the bitstream, the data amount of the bitstream can be reduced, and thus the processing amount of the three-dimensional data decoding device can be reduced.

For example, the three-dimensional data decoding device includes a processor and memory, and the processor performs the above processes using the memory.

Furthermore, a three-dimensional data encoding device according to the present disclosure performs the process illustrated in FIG. 15. The three-dimensional data encoding device determines a reference three-dimensional point among three-dimensional points each of which is represented by a first angle, a second angle, and a distance (S211); and performs, according to the first angle of the reference three-dimensional point, at least one of arithmetic encoding or binarizing on information of a current three-dimensional point included in the three-dimensional points, the information excluding the first angle (S212). For example, the three-dimensional data encoding device generates a bitstream including the information excluding the first angle, after the at least one of the arithmetic encoding or the binarization has been performed thereon.

Accordingly, in a case where, for example, information of a three-dimensional point has a tendency that is dependent on the first angle, the three-dimensional data encoding device can improve encoding efficiency by using a method of at least one of arithmetic encoding or binarizing that is in accordance with the tendency.

For example, the reference three-dimensional point is the same as the current three-dimensional point. Accordingly, the three-dimensional data encoding device can switch the method of the at least one of arithmetic encoding or binarizing of information of the current three-dimensional point excluding the first angle, according to the first angle of the current three-dimensional point. Here, it is more likely that the tendency of the information of the current three-dimensional point is represented by the first angle of the current three-dimensional point than a first angle of a three-dimensional point other than the current three-dimensional point. Therefore, the three-dimensional data encoding device may be able to improve encoding efficiency compared to when the first angle of a three-dimensional point other than the current three-dimensional point is referred to.

For example, the reference three-dimensional point corresponds to a parent node of the current three-dimensional point, in a predictive tree of the three-dimensional points. Specifically, the reference three-dimensional point may be a three-dimensional point other than the current three-dimensional point. Furthermore, the reference three-dimensional point may be a decoded three-dimensional point. For example, the reference three-dimensional point may be the three-dimensional point immediately before the current three-dimensional point in encoding order.

A predictive tree is a data structure generated according to prediction processing of a three-dimensional point. Therefore, it is highly likely that a tendency exists between the first angle of the reference three-dimensional point corresponding to a parent node and the information of the current three-dimensional point corresponding to the child node thereof. Furthermore, a three-dimensional data decoding device that decodes a bitstream generated by a three-dimensional data encoding device can reduce the processing delay on the decoding of the first angle since the reference three-dimensional point corresponding to the parent node is decoded before the current three-dimensional point.

For example, a first scheme of the at least one of the arithmetic encoding or the binarizing is used when the first angle is greater than a threshold, and a second scheme of the at least one of the arithmetic encoding or the binarizing is used when the first angle is less than or equal to the threshold, the second scheme being different from the first scheme.

Accordingly, in a case where, for example, information of a three-dimensional point has a tendency that is dependent on whether the first angle is greater than a threshold, that is, a tendency that is dependent on the range the first angle, the three-dimensional data encoding device can improve encoding efficiency by using a method of at least one of arithmetic encoding or binarizing that is in accordance with the tendency.

For example, a first context used in the first scheme of the arithmetic encoding is different from a second context used in the second scheme of the arithmetic encoding. It should be noted that a plurality of contexts may be used in each scheme. In other words, a first context group may used in the first scheme of the arithmetic decoding, and a second context group different from the first context group may be used in the second scheme of the arithmetic decoding.

Accordingly, the three-dimensional data encoding device can improve encoding efficiency in a case where, for example, information of a three-dimensional point has a tendency that is dependent on the first angle, by switching contexts in accordance with the first angle.

For example, a first bit length of a binarized symbol in the first scheme of the binarizing is different from a second bit length of a binarized symbol in the second scheme of the binarizing. Specifically, a first binarization table to be used in the first scheme and indicating the relationship between a value before transforming and a binarized symbol after transforming, may be different from a second binarization table to be used in the second scheme.

Accordingly, the three-dimensional data encoding device can improve encoding efficiency in a case where, for example, information of a three-dimensional point has a tendency that is dependent on the first angle, by switching binarized symbols in accordance with the first angle.

For example, the three-dimensional points are encoded in ascending order of the first angles of the three-dimensional points, and when the first angle is greater than a threshold, a context of the arithmetic encoding is initialized. It should be noted that it is also acceptable that the encoded three-dimensional points are decoded in descending order of the first angles of the three-dimensional points, and when the first angle is less than the threshold, the context of the arithmetic decoding is initialized.

Accordingly, the three-dimensional data encoding device can use a different context when the first angle is greater than the threshold and when the first angle is less than or equal to the first angle, by initializing the context when the first angle is greater than the threshold. Consequently, the three-dimensional data encoding device can improve encoding efficiency in a case where, for example, information of a three-dimensional point has a tendency that is dependent on the first angle.

It should be noted that the information excluding the first angle includes at least one of the second angle, the distance, or prediction information of the current three-dimensional point. Accordingly, the three-dimensional data encoding method can improve the encoding efficiency of at least one of the second angle, the distance, or the prediction information.

It should be noted that the first angle is an elevation angle and the second angle is a horizontal angle, and the first angle corresponds to a laser ID used for generating the three-dimensional points.

Accordingly, in a case where, for example, information of a three-dimensional point has a tendency that is dependent on the range of a vertical direction position of the three-dimensional point, the three-dimensional data encoding method can improve encoding efficiency by using a method of at least one of arithmetic encoding or binarizing that is in accordance with the tendency.

For example, the three-dimensional data encoding device includes a processor and memory, and the processor performs the above processes using the memory.

A three-dimensional data encoding a device, three-dimensional data decoding device, and the like, according to embodiments of the present disclosure and variations of the embodiments have been described above, but the present disclosure is not limited to these embodiments, etc.

Note that each of the processors included in the three-dimensional data encoding device, the three-dimensional data decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as a three-dimensional data encoding method, a three-dimensional data decoding method, or the like executed by the three-dimensional data encoding device, the three-dimensional data decoding device, and the like.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

A three-dimensional data encoding device, a three-dimensional data decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to a three-dimensional data encoding device and a three-dimensional data decoding device.

1. A three-dimensional data decoding method comprising:
obtaining a bitstream including encoded three-dimensional points generated by encoding three-dimensional points each of which is represented by a first angle, a second angle, and a distance;
determining a reference three-dimensional point among the three-dimensional points; and
performing, according to the first angle of the reference three-dimensional point, at least one of arithmetic decoding or debinarizing on encoded information of a current encoded three-dimensional point included in the encoded three-dimensional points to generate information of a current three-dimensional point included in the three-dimensional points, the information excluding the first angle.

2. The three-dimensional data decoding method according to claim 1, wherein
the reference three-dimensional point is same as the current three-dimensional point.

3. The three-dimensional data decoding method according to claim 1, wherein
the reference three-dimensional point corresponds to a parent node of the current three-dimensional point, in a predictive tree of the three-dimensional points.

4. The three-dimensional data decoding method according to claim 1, wherein
a first scheme of the at least one of the arithmetic decoding or the debinarizing is used when the first angle is greater than a threshold, and
a second scheme of the at least one of the arithmetic decoding or the debinarizing is used when the first angle is less than or equal to the threshold, the second scheme being different from the first scheme.

5. The three-dimensional data decoding method according to claim 4, wherein
a first context used in the first scheme of the arithmetic decoding is different from a second context used in the second scheme of the arithmetic decoding.

6. The three-dimensional data decoding method according to claim 4, wherein
a first bit length of a binarized symbol in the first scheme of the debinarizing is different from a second bit length of a binarized symbol in the second scheme of the debinarizing.

7. The three-dimensional data decoding method according to claim 1, wherein
the encoded three-dimensional points are decoded in ascending order of the first angles of the three-dimensional points, and
when the first angle is greater than a threshold, a context of the arithmetic decoding is initialized.

8. The three-dimensional data decoding method according to claim 1, wherein
the information includes at least one of the second angle, the distance, or prediction information of the current three-dimensional point.

9. The three-dimensional data decoding method according to claim 1, wherein
the first angle is an elevation angle and the second angle is a horizontal angle, and
the first angle corresponds to a laser ID used for generating the three-dimensional points.

10. A three-dimensional data encoding method comprising:
determining a reference three-dimensional point among three-dimensional points each of which is represented by a first angle, a second angle, and a distance; and
performing, according to the first angle of the reference three-dimensional point, at least one of arithmetic encoding or binarizing on information of a current three-dimensional point included in the three-dimensional points, the information excluding the first angle.

11. The three-dimensional data encoding method according to claim 10, wherein
the reference three-dimensional point is same as the current three-dimensional point.

12. The three-dimensional data encoding method according to claim 10, wherein
the reference three-dimensional point corresponds to a parent node of the current three-dimensional point, in a predictive tree of the three-dimensional points.

13. The three-dimensional data encoding method according to claim 10, wherein
a first scheme of the at least one of the arithmetic encoding or the binarizing is used when the first angle is greater than a threshold, and
a second scheme of the at least one of the arithmetic encoding or the binarizing is used when the first angle is less than or equal to the threshold, the second scheme being different from the first scheme.

14. The three-dimensional data encoding method according to claim 13, wherein
a first context used in the first scheme of the arithmetic encoding is different from a second context used in the second scheme of the arithmetic encoding.

15. The three-dimensional data encoding method according to claim 13, wherein
a first bit length of a binarized symbol in the first scheme of the binarizing is different from a second bit length of a binarized symbol in the second scheme of the binarizing.

16. The three-dimensional data encoding method according to claim 10, wherein
the three-dimensional points are encoded in ascending order of the first angles of the three-dimensional points, and
when the first angle is greater than a threshold, a context of the arithmetic encoding is initialized.

17. The three-dimensional data encoding method according to claim 10, wherein
the information includes at least one of the second angle, the distance, or prediction information of the current three-dimensional point.

18. The three-dimensional data encoding method according to claim 10, wherein
the first angle is an elevation angle and the second angle is a horizontal angle, and
the first angle corresponds to a laser ID used for generating the three-dimensional points.

19. A three-dimensional data decoding device comprising:
a processor; and
memory, wherein
using the memory, the processor:
obtains a bitstream including encoded three-dimensional points generated by encoding three-dimensional points each of which is represented by a first angle, a second angle, and a distance;
determines a reference three-dimensional point among the three-dimensional points; and
performs, according to the first angle of the reference three-dimensional point, at least one of arithmetic decoding or debinarizing on encoded information of a current encoded three-dimensional point included in the encoded three-dimensional points to generate information of a current three-dimensional point included in the three-dimensional points, the information excluding the first angle.

20. A three-dimensional data encoding device comprising:
a processor; and
memory, wherein
using the memory, the processor:
determines a reference three-dimensional point among three-dimensional points each of which is represented by a first angle, a second angle, and a distance; and
performs, according to the first angle of the reference three-dimensional point, at least one of arithmetic encoding or binarizing on information of a current three-dimensional point included in the three-dimensional points, the information excluding the first angle.
